(19) United States
(12) Patent Application Publication
(10) Pub. No.: US 2013/0172471 A1
(43) Pub. Date: Jul. 4, 2013

(54) Biphenyl Polyphosphonate, Method for Preparing the Same and Thermoplastic Resin Composition Including the Same

(71) Applicant: Cheil Industries Inc., Kumi-city (KR)

(72) Inventors: Min Soo LEE, Uiwang-si (KR); Chang Hong KO, Uiwang-si (KR); Sung Hee AHN, Uiwang-si (KR); Seon Ae LEE, Uiwang-si (KR); Seung Woo JANG, Uiwang-si (KR); Sang Hyun HONG, Uiwang-si (KR)

(73) Assignee: CHEIL INDUSTRIES INC., Kumi-city (KR)

(21) Appl. No.: 13/652,650

(22) Filed: Oct. 16, 2012

(30) Foreign Application Priority Data
Dec. 29, 2011 (KR) 10-2011-0146571
Dec. 30, 2011 (KR) 10-2011-0147629

(51) Int. Cl. C08L 85/02; C08G 79/04

(52) U.S. Cl. 524/508; 528/169; 525/394; 525/133; 524/537

(57) ABSTRACT

Disclosed herein is a biphenyl polyphosphonate. The biphenyl polyphosphonate is represented by Formula 1:

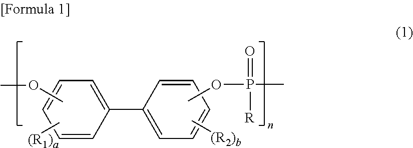

wherein R is hydrogen, substituted or unsubstituted C₁-C₅ alkyl, substituted or unsubstituted C₂-C₅ alkenyl, substituted or unsubstituted C₅-C₆ cycloalkyl, substituted or unsubstituted C₅-C₆ cycloalkenyl, substituted or unsubstituted C₆-C₂₀ aryl, or substituted or unsubstituted C₆-C₂₀ aryloxy, R₁ and R₂ are the same or different and are each independently substituted or unsubstituted C₁-C₆ alkyl, substituted or unsubstituted C₅-C₆ cycloalkyl, substituted or unsubstituted C₆-C₁₂ aryl, or halogen, a and b are the same or different and are each independently an integer from about 0 to about 4, and n is an integer from about 4 to about 500.

### CROSS-REFERENCE TO RELATED APPLICATIONS

This application claims priority under 35 USC Section 119 to and the benefit of Korean Patent Application No. 10-2011-0146571 filed on Dec. 29, 2011 and Korean Patent Application 10-2011-0147629 filed on Dec. 30, 2011, the entire disclosure of each of which is incorporated herein by reference.

### FIELD OF THE INVENTION

The present invention relates to a biphenyl polyphosphonate, a method for preparing the biphenyl polyphosphonate, and a thermoplastic resin composition including the biphenyl polyphosphonate.

### BACKGROUND OF THE INVENTION

With growing interest in environmental issues, stringent regulations restricting the use of halogenated flame retardants have been increasingly enacted in many countries. Under such circumstances, considerable research efforts have been made in developing non-halogen flame retardants. Further research has concentrated on phosphorus-based flame retardants as substitutes for halogenated flame retardants.

Phosphoric acid esters are presently the most widely used phosphorus-based flame retardants. The phosphoric acid esters are monomeric phosphorus-based flame retardants and include triphenyl phosphate and resorcinol bisphenol phosphate. However, such monomeric phosphorus-based flame retardants tend to be volatile during high-temperature molding into plastics due to their low molecular weights. This tendency towards volatility brings about poor appearance of the plastics and the monomeric phosphorus-based flame retardants may be released into nature during use of the final products, causing environmental pollution problems.

Thus, there is an increasing interest in polyphosphonates as polymeric phosphorus-based flame retardants. Polymeric polyphosphonates can have better flame retardancy, mechanical properties, heat resistance and transparency than monomeric phosphorus-based flame retardants, and thus can be suitable for use in resins, particularly polycarbonate resins, which require good heat resistance and high transparency.

Polyphosphonates developed hitherto contain moieties derived from bisphenol A as a reactant in the main chains thereof. The use of polyphosphonates having such structures can lead to unsatisfactory results in terms of impact strength, heat resistance and appearance and can have the ability to partially decompose thermoplastic resins in view of structural characteristics, causing the possibility that the physical properties of the thermoplastic resins may deteriorate.

### SUMMARY OF THE INVENTION

The present invention provides a biphenyl polyphosphonate that can exhibit good flame retardancy, heat resistance, impact strength, transparency and appearance, can have a low acid value, and may not decompose a thermoplastic resin due to the presence of biphenyl moieties introduced into the structure thereof. The present invention also provides a method for preparing the biphenyl polyphosphonate, and a thermoplastic resin composition including the biphenyl polyphosphonate. The thermoplastic resin composition including the biphenyl polyphosphonate into which biphenyl moieties are introduced as a flame retardant can exhibit a good balance of physical properties, such as transparency, heat resistance, impact strength and appearance, as well as flame retardancy, and can be environmentally friendly without any danger of gas release or decomposition.

The biphenyl polyphosphonate is represented by Formula 1:

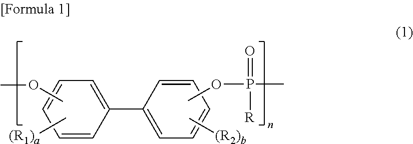

wherein:

R is hydrogen, substituted or unsubstituted C₁-C₅ alkyl, substituted or unsubstituted C₂-C₅ alkenyl, substituted or unsubstituted C₅-C₆ cycloalkyl, substituted or unsubstituted C₅-C₆ cycloalkenyl, substituted or unsubstituted C₆-C₂₀ aryl, or substituted or unsubstituted C₆-C₂₀ aryloxy,

R₁ and R₂ are the same or different and are each independently substituted or unsubstituted C₁-C₆ alkyl, substituted or unsubstituted C₅-C₆ cycloalkyl, substituted or unsubstituted C₆-C₁₂ aryl, or halogen,

a and b are the same or different and are each independently an integer from about 0 to about 4, and

n is an integer from about 4 to about 500.

The biphenyl polyphosphonate may have a weight average molecular weight of about 1,000 to about 50,000 g/mol.

The biphenyl polyphosphonate may have an acid value of about 0.005 to about 4 KOH mg/g.

The biphenyl polyphosphonate may have a polydispersity index (PDI) of about 1.0 to about 3.5.

In one embodiment, the biphenyl polyphosphonate may have a weight average molecular weight of about 1,000 to about 10,000 g/mol and a polydispersity index (PDI) of about 1.5 to about 3.0.

The present invention further provides a method for preparing the foregoing biphenyl polyphosphonate represented by Formula 1. The method includes reacting a biphenol represented by Formula 2, a phosphonic dichloride represented by Formula 3 and an end-capping agent in the presence of a Lewis acid catalyst:

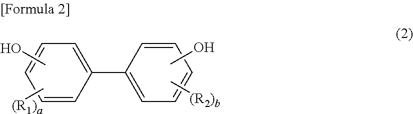

wherein R₁, R₂, a and b are as defined in Formula 1,

a phosphonic dichloride represented by Formula 3:

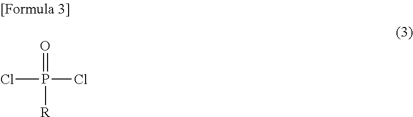

wherein R is as defined in Formula 1.

In exemplary embodiments, the end-capping agent may be a C₁-C₅ alkyl group-containing phenol.

The present invention further provides a thermoplastic resin composition including the biphenyl polyphosphonate. The thermoplastic resin composition includes the biphenyl polyphosphonate and a thermoplastic resin.

In one embodiment, the thermoplastic resin composition includes about 100 parts by weight of the thermoplastic resin and about 0.1 to about 30 parts by weight of the biphenyl polyphosphonate.

The thermoplastic resin composition may have a heat resistance of about 136 to about 160° C., as measured at 5 kg and 50° C./HR in accordance with ISO R 306, a ⅛″ notched Izod impact strength of about 8.5 to about 80 kgf·cm/cm, as measured in accordance with ASTM D-256, and a flame retardancy rating of V-2 or better, as measured at a thickness of ⅛″ in accordance with UL94 V.

In one embodiment, the thermoplastic resin composition includes: about 100 parts by weight of a base resin including an aromatic vinyl resin and a polyphenylene oxide resin; and about 0.1 to about 30 parts by weight of the foregoing biphenyl polyphosphonate represented by Formula 1.

The base resin may include about 50 to about 99% by weight of the aromatic vinyl resin and about 1 to about 50% by weight of the polyphenylene oxide resin.

The aromatic vinyl resin may be a polymer of about 1 to about 30% by weight of a rubbery polymer and about 70 to about 99% by weight of an aromatic vinyl monomer.

The biphenyl polyphosphonate may have a weight average molecular weight of about 1,000 to about 50,000 g/mol.

The biphenyl polyphosphonate may have an acid value of about 0.005 to about 4 mg KOH/g.

The biphenyl polyphosphonate may have a polydispersity index (PDI) of about 1.0 to about 3.5.

The biphenyl polyphosphonate may have a weight average molecular weight of about 1,000 to about 10,000 g/mol and a polydispersity index (PDI) of about 1.5 to about 3.

The thermoplastic resin composition may further include one or more additives selected from the group consisting of flame retardant assistants, lubricants, plasticizers, heat stabilizers, anti-drip agents, antioxidants, compatibilizers, light stabilizers, pigments, dyes, inorganic additives, and the like, and combinations thereof.

The present invention also provides a molded article produced by molding the thermoplastic resin composition.

### BRIEF DESCRIPTION OF THE DRAWING

FIG. 1 is an NMR spectrum of a biphenyl polyphosphonate prepared in Preparation Example 1 of the present application.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

Biphenyl Polyphosphonate

The present invention provides a biphenyl polyphosphonate. The biphenyl polyphosphonate is represented by Formula 1:

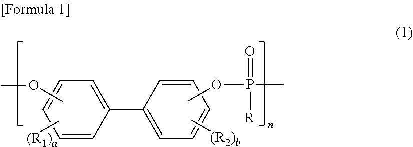

wherein:

R is hydrogen, substituted or unsubstituted C₁-C₅ alkyl, substituted or unsubstituted C₂-C₅ alkenyl, substituted or unsubstituted C₅-C₆ cycloalkyl, substituted or unsubstituted C₅-C₆ cycloalkenyl, substituted or unsubstituted C₆-C₂₀ aryl, or substituted or unsubstituted C₆-C₂₀ aryloxy,

R₁ and R₂ are the same or different and are each independently substituted or unsubstituted C₁-C₆ alkyl, substituted or unsubstituted C₅-C₆ cycloalkyl, substituted or unsubstituted C₆-C₁₂ aryl, or halogen,

a and b are the same or different and are each independently an integer from about 0 to about 4, and

n is an integer from about 4 to about 500.

The term ‘substituted’ as used herein refers to substitution of one or more hydrogens with a halogen atom, a hydroxyl group, a nitro group, a cyano group, an amino group, an azido group, an amidino group, a hydrazino group, a carbonyl group, a carbamyl group, a thiol group, an ester group, a carboxyl group or a salt thereof, a sulfonic acid group or a salt thereof, a phosphate group or a salt thereof, a C₁-C₂₀ alkyl group, a C₂-C₂₀ alkenyl group, a C₂-C₂₀ alkynyl group, a C₁-C₂₀ alkoxy group, a C₆-C₃₀ aryl group, a C₆-C₃₀ aryloxy group, a C₃-C₃₀ cycloalkyl group, a C₃-C₃₀ cycloalkenyl group, a C₃-C₃₀ cycloalkynyl group, or a combination thereof.

The biphenyl polyphosphonate may be prepared by reacting a biphenol represented by Formula 2 with a phosphonic dichloride represented by Formula 3 and an end-capping agent in the presence of a Lewis acid catalyst:

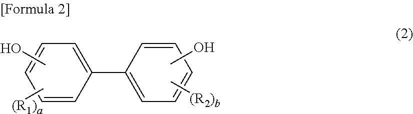

wherein:

R₁ and R₂ are the same or different and are each independently substituted or unsubstituted C₁-C₆ alkyl, substituted or unsubstituted C₅-C₆ cycloalkyl, substituted or unsubstituted C₆-C₁₂ aryl, or halogen, and

a and b are the same or different and are each independently an integer from about 0 to about 4,

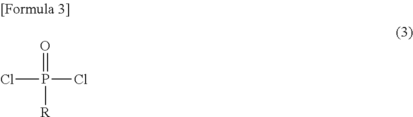

wherein R is hydrogen, substituted or unsubstituted C₁-C₅ alkyl, substituted or unsubstituted C₂-C₅ alkenyl, substituted or unsubstituted C₅-C₆ cycloalkyl, substituted or unsubstituted C₅-C₆ cycloalkenyl, substituted or unsubstituted C₆-C₂₀ aryl, or substituted or unsubstituted C₆-C₂₀ aryloxy.

As the phosphonic dichloride represented by Formula 3, there may be used a mixture of two phosphonic dichlorides having different substituents R.

In one embodiment, the reaction may be carried out by dropwise addition of the phosphonic dichloride to a mixed solution of the biphenol, the catalyst and the end-capping agent.

4,4′-dihydroxybiphenyl can be used as the biphenol.

In one embodiment, the biphenol may be used in an amount of about one equivalent, based on about one equivalent of the phosphonic dichloride.

The reaction of the biphenol and the phosphonic dichloride may be carried out by a general polymerization process in the presence of the Lewis acid catalyst. The polymerization process can be a solution polymerization.

Examples of the catalyst may include without limitation aluminum chloride, magnesium chloride, and the like, and combinations thereof. The catalyst may be used in an amount of about 0.01 to about 10 equivalents, for example about 0.01 to about 0.1 equivalents, based on about one equivalent of the biphenol.

The reaction may be carried out in the presence of the end-capping agent. The end-capping agent can be a phenol or a phenol including one or more substituents. Examples of the phenol substituents include without limitation C₁-C₆ alkyl substituents, C₆-C₂₀ aryl substituents, and the like, and combinations thereof. The end-capping agent may be used in an amount of about 0.01 to about 0.5 equivalents, based on about one equivalent of the biphenol.

In one embodiment, the reaction product may be washed with an acid solution. Examples of the acid solution may include without limitation phosphoric acid, hydrochloric acid, nitric acid, sulfuric acid, and the like, and combinations thereof. In exemplary embodiments, the acid solution may include phosphoric acid or hydrochloric acid. The acid solution can have a concentration of about 0.1 to about 10%, for example about 1 to about 5%.

Subsequent washing and filtration yield the biphenyl polyphosphonate in the form of a solid. The biphenyl polyphosphonate has a linear structure and is free of bisphenol moieties in the structure thereof.

The biphenyl polyphosphonate may have a weight average molecular weight of about 1,000 to about 50,000 g/mol, for example about 1,000 to about 20,000 g/mol, and as another example about 1,000 to about 10,000 g/mol. When the biphenyl polyphosphonate has a molecular weight within this range, better flame retardancy can be imparted. The weight average molecular weight is measured by gel permeation chromatography (GPC). Specifically, 0.01 g of a sample of the biphenyl polyphosphonate is dissolved in 2 mL of methylene chloride (MC), diluted with about 10 mL of THF, filtered through a 0.45 tm syringe filter, followed by gel permeation chromatography (GPC).

The biphenyl polyphosphonate may have an acid value of about 0.005 to about 4 KOH mg/g, for example about 0.01 to about 0.05 KOH mg/g. When the biphenyl polyphosphonate has an acid value within this range, decomposition of a thermoplastic resin can be minimized.

The acid value can be measured in accordance with the following procedure. First, a sample of the biphenyl polyphosphonate is dissolved in dimethyl sulfoxide (50 ml). To the solution is added a small amount of a BTB solution. The resulting mixture is titrated with a 0.1 N NaOH solution. The acid value can be calculated by Equation 1:

[Equation 1]

Acid value=[(Amount of 0.1 N NaOH solution consumed (ml))*(0.1 N NaOH solution factor)*5.61]/Sample amount (g) (1)

The biphenyl polyphosphonate may have a polydispersity index (PDI) of about 1.0 to about 3.5, for example about 1.5 to about 3.0. When the biphenyl polyphosphonate has a polydispersity index within this range, stable and sustainable physical properties of the biphenyl polyphosphonate can be reproduced.

The biphenyl polyphosphonate prepared by the method of the present invention can have a low acid value and can be highly flame retardant, heat resistant and transparent. Due to these advantages, the biphenyl polyphosphonate can be used with resins which require good heat resistance, transparency and impact resistance.

In addition, the biphenyl polyphosphonate can be used as a flame retardant without causing or minimizing decomposition of a thermoplastic resin.

Thermoplastic Resin Composition

The present invention also provides a thermoplastic resin composition including the biphenyl polyphosphonate and a thermoplastic resin.

There is no particular restriction as to the kind of the thermoplastic resin. Examples of thermoplastic resins suitable for use in the thermoplastic resin composition include, but are not necessarily limited to, styrene resins, polyamide resins, polycarbonate resins, polyester resins, polyvinyl chloride resins, styrene copolymer resins, (meth)acrylic resins, polyphenylene ether resins, and the like, and combinations thereof.

The thermoplastic resin composition may include the biphenyl polyphosphonate in an amount of about 0.1 to about 30 parts by weight, for example about 3 to about 20 parts by weight, based on about 100 parts by weight of the thermoplastic resin. In some embodiments, the thermoplastic resin composition may include the biphenyl polyphosphonate in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the biphenyl polyphosphonate can be in a range from about any of the foregoing amounts to about any other of the foregoing amounts.

In one embodiment, the thermoplastic resin composition of the present invention may include about 100 parts by weight of polycarbonate and about 0.1 to about 30 parts by weight, for example, about 1 to about 15 parts by weight, and as another example about 3 to about 12 parts by weight of the biphenyl polyphosphonate.

The thermoplastic resin composition may have a heat resistance of about 136 to about 160° C., as measured at 5 kg and 50° C./HR in accordance with ISO R 306, a ⅛″ notched Izod impact strength of about 8.5 to about 80 kgf·cm/cm, as measured in accordance with ASTM D-256, and a flame retardancy rating of V-2 or better, as measured at a thickness of ⅛″ in accordance with UL94 V.

In another embodiment, the thermoplastic resin composition of the present invention includes: a base resin including (A) an aromatic vinyl resin and (B) a polyphenylene oxide resin; and the biphenyl polyphosphonate. A detailed explanation will now be given regarding the individual components of the thermoplastic resin composition.

(A) Aromatic Vinyl Resin

The aromatic vinyl resin may be a polymer of an aromatic vinyl monomer, a copolymer of an aromatic vinyl monomer and a monomer copolymerizable with the aromatic vinyl monomer, or a rubber-modified aromatic vinyl resin, which is a copolymer of the aromatic vinyl monomer and a rubbery polymer.

Examples of suitable aromatic vinyl monomers include without limitation styrene, α-methylstyrene, β-methylstyrene, p-methylstyrene, para-t-butylstyrene, ethylstyrene, and the like. These aromatic vinyl monomers may be used alone or as a mixture of two or more thereof.

Examples of suitable monomers copolymerizable with the aromatic vinyl monomers include without limitation acrylonitrile, acrylic acid, methacrylic acid, maleic anhydride, N-substituted maleimide, and the like. These copolymerizable monomers may be used alone or as a mixture of two or more thereof.

Examples of suitable rubbery polymers include without limitation diene rubbers, such as butadiene rubbers, copolymers of butadiene and styrene, and poly(acrylonitrile-butadiene), saturated rubbers obtained by hydrogenation of the diene rubbers, isoprene rubbers, acrylic rubbers, terpolymers of ethylene-propylene-diene monomers (EPDM), and the like, and combinations thereof In exemplary embodiments, polybutadiene, copolymers of butadiene and styrene, isoprene rubbers, alkyl acrylate rubbers, and the like can be used.

When the aromatic vinyl resin (A) is a rubber-modified aromatic vinyl resin, the aromatic vinyl resin (A) can include a rubbery polymer in an amount of about 1 to about 30% by weight, for example about 5 to 15% by weight, based on the total weight of the aromatic vinyl resin (A). In some embodiments, the aromatic vinyl resin (A) can include the rubbery polymer in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the amount of the rubbery polymer can be in a range from about any of the foregoing amounts to about any other of the foregoing amounts.

The Z-average particle size of the rubber phase in a blend of the rubber-modified aromatic vinyl resin and the polyphenylene oxide resin can range from about 0.1 to about 6.0 μm, for example from about 0.25 to about 3.5 μm. When the Z-average particle size of the rubber phase is within this range, suitable physical properties can be exhibited.

Also when the aromatic vinyl resin (A) is a rubber-modified aromatic vinyl resin, the aromatic vinyl resin (A) can include the aromatic vinyl monomer (singly or in combination with other monomers polymerizable therewith) in an amount of about 70 to about 99% by weight, based on the total weight of the aromatic vinyl resin (A). In some embodiments, the aromatic vinyl resin (A) can include the aromatic vinyl monomer (singly or in combination with other monomers polymerizable therewith) in an amount of about 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% by weight. Further, according to some embodiments of the present invention, the amount of the aromatic vinyl monomer (singly or in combination with other monomers polymerizable therewith) can be in a range from about any of the foregoing amounts to about any other of the foregoing amounts.

Examples of the aromatic vinyl resin (A) may include without limitation polystyrene (PS), high impact polystyrene (HIPS), acrylonitrile-butadiene-styrene (ABS) copolymer resins, acrylonitrile-styrene (SAN) copolymer resins, acrylonitrile-styrene-acrylate (ASA) copolymer resins, and the like, and mixtures thereof. Polystyrene (PS) or high impact polystyrene (HIPS) can provide compatibility with the polyphenylene ether resin.

The aromatic vinyl resin (A) can be prepared by suitable methods known to those having ordinary knowledge in the art to which the invention pertains and is readily commercially available.

In one embodiment, the aromatic vinyl resin (A) may be prepared by thermal polymerization in the absence of an initiator or by polymerization in the presence of an initiator. Examples of initiators suitable for use in the polymerization include, but are not necessarily limited to: peroxide initiators, such as benzoyl peroxide, t-butyl hydroperoxide, acetyl peroxide and cumene hydroperoxide; and azo initiators, such as azobisisobutyronitrile. These initiators may be used alone or as a mixture thereof.

The aromatic vinyl resin (A) may be prepared by bulk polymerization, suspension polymerization, emulsion polymerization or a combination thereof. In exemplary embodiments, the aromatic vinyl resin (A) may be prepared by bulk polymerization.

In exemplary embodiments, the aromatic vinyl resin (A) can be a constituent of a base resin of the composition of the present invention. The base resin can include the aromatic vinyl resin (A) in an amount of about 50 to about 99% by weight, for example about 55 to about 80% by weight, and as another example about 55 to about 75% by weight, based on the total weight of the base resin including the aromatic vinyl resin (A) and the polyphenylene oxide resin (B). In some embodiments, the base resin may include the aromatic vinyl resin (A) in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% by weight. Further, according to some embodiments of the present invention, the amount of the aromatic vinyl resin (A) can be in a range from about any of the foregoing amounts to about any other of the foregoing amounts.

When the base resin includes the aromatic vinyl resin (A) in an amount within this range, the thermoplastic resin composition of the present invention including the same can have a good balance of impact strength and flowability.

(B) Polyphenylene Ether Resin

Examples of the polyphenylene ether resin (B) may include without limitation poly(2,6-dimethyl-1,4-phenylene)ether, poly(2,6-diethyl-1,4-phenylene)ether, poly(2,6-dipropyl-1,4-phenylene)ether, poly(2-methyl-6-ethyl-1,4-phenylene)ether, poly(2-methyl-6-propyl-1,4-phenylene)ether, poly(2-ethyl-6-propyl-1,4-phenylene)ether, poly(2,6-diphenyl-1,4-phenylene)ether, a copolymer of poly(2,6-dimethyl-1,4-phenylene)ether and poly(2,3,6-trimethyl-1,4-phenylene)ether, a copolymer of poly(2,6-dimethyl-1,4-phenylene)ether and poly(2,3,6-triethyl-1,4-phenylene)ether, and the like, and combinations thereof. In exemplary embodiments, poly(2,6-dimethyl-1,4-phenylene)ether or a copolymer of poly(2,6-dimethyl-1,4-phenylene)ether and poly(2,3,6-trimethyl-1,4-phenylene)ether can be used.

The degree of polymerization of the polyphenylene ether resin used in the preparation of the composition according to the present invention is not particularly limited. Generally the degree of polymerization of the polyphenylene ether resin can be determined such that the polyphenylene ether resin has an intrinsic viscosity of about 0.2 to about 0.8 dl/g, as measured in chloroform as a solvent at 25° C., taking into consideration thermal stability and workability of the resin composition.

The polyphenylene ether resin (B) can be another constituent of the base resin of the composition of the present invention. The base resin can include the polyphenylene ether resin (B) in an amount of about 1 to about 50% by weight, for example about 20 to about 45% by weight, and as another example about 25 to about 45% by weight, based on the total weight of the base resin including the aromatic vinyl resin (A) and the polyphenylene oxide resin (B). In some embodiments, the base resin may include the polyphenylene ether resin (B) in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the amount of the polyphenylene ether resin (B) can be in a range from about any of the foregoing amounts to about any other of the foregoing amounts.

When the base resin includes the polyphenylene ether resin (B) in an amount within this range, the characteristics of the polyphenylene ether resin can be appropriately exhibited, which can provide excellent flowability and impact resistance of the resin composition.

The thermoplastic resin composition can include the biphenyl polyphosphonate in an amount of about 0.1 to about 30 parts by weight, for example, about 1 to about 25 parts by weight, and as another example about 10 to 20 parts by weight, based on about 100 parts by weight of the base resin including resins (A) and (B). In some embodiments, the thermoplastic resin composition may include the biphenyl polyphosphonate in an amount of about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight. Further, according to some embodiments of the present invention, the amount of the biphenyl polyphosphonate can be in a range from about any of the foregoing amounts to about any other of the foregoing amounts.

When the thermoplastic resin composition includes the biphenyl polyphosphonate in an amount within this range, a good balance of physical properties such as flame retardancy, flowability, impact strength and heat resistance can be achieved.

In one embodiment, the thermoplastic resin composition may have a heat resistance of about 126 to about 145° C., as measured at 5 kg and 50° C./HR in accordance with ISO R 306, a ⅛″ notched Izod impact strength of about 8.6 to about 50 kgf·cm/cm, as measured in accordance with ASTM D-256, and a flame retardancy rating of V-1 or better, as measured at a thickness of ⅛″ in accordance with UL94 V.

If necessary, the thermoplastic resin composition of the present invention may further include one or more additives. Examples of the additives include without limitation flame retardant assistants, lubricants, plasticizers, heat stabilizers, anti-drip agents, antioxidants, compatibilizers, light stabilizers, pigments, dyes, inorganic additives, and the like, and combinations thereof.

The thermoplastic resin composition of the present invention can be molded into various articles by known molding techniques. For example, the constituent components and optionally other additives can be mixed together all at once, melt-extruded into pellets in an extruder, and molded into a desired article by a suitable molding technique, for example, injection molding, extrusion molding, vacuum forming or casting.

The present invention further provides a molded article. The molded articles can be produced by molding the thermoplastic resin composition. The molded article can have excellent physical properties in terms of impact resistance, flowability and flame retardancy. Due to these advantages, the molded article can be used in various applications, including parts of electrical and electronic products, exterior materials, automotive components, miscellaneous goods and structural materials.

Next, the constitution and functions of the present invention will be explained in more detail with reference to the following examples. It should be understood that these examples are provided for illustrative purposes only and are not to be in any way construed as limiting the present invention. A description of details apparent to those skilled in the art will be omitted herein.

### EXAMPLES

### Preparation Examples 1-3

### Preparation of Biphenyl Polyphosphonates

### Preparation Example 1

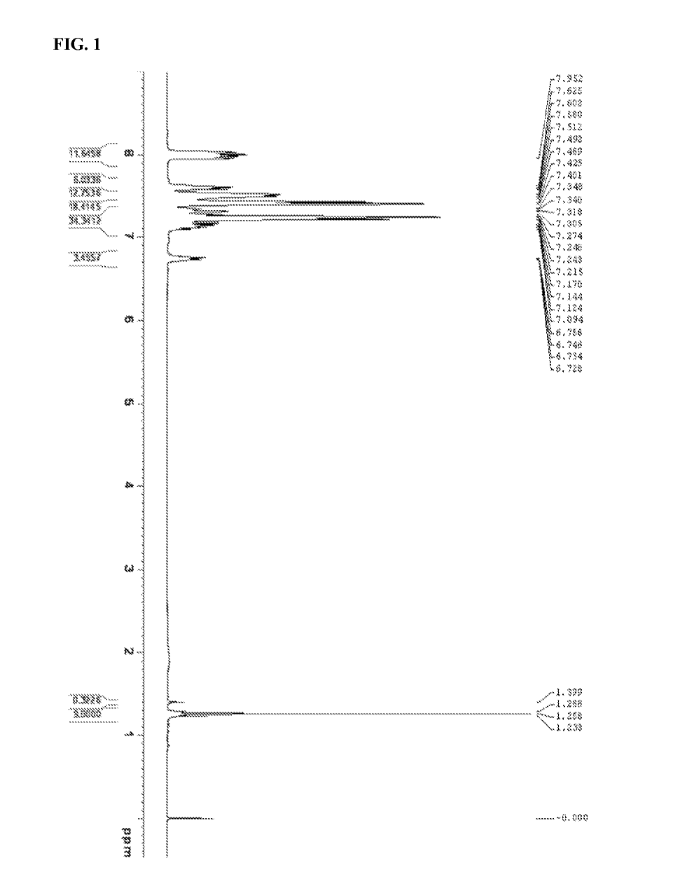

1 equivalent of a biphenol (Songwon Industrial Co., Ltd., Korea), 0.1 equivalents of 4-t-butylphenol as an end-capping agent, and 0.01 equivalents of aluminum chloride are added to chlorobenzene whose amount was 6 times larger than that of the biphenol. The mixture is heated to 131° C., and then 1 equivalent of phenylphosphonic dichloride (Acros) is added dropwise thereto to initiate the reaction. After the dropwise addition is finished, the resulting mixture is further stirred for 2 hr. After completion of the reaction, the reaction mixture is cooled to 80° C., washed with a 10% aqueous hydrochloric acid solution, and washed twice with water. Thereafter, the aqueous layer is discarded and the organic layer is distilled under reduced pressure, affording a biphenyl polyphosphonate as a product in a yield of 99%. NMR data (300 MHz, Bruker) for the polymer are shown in FIG. 1.

### Preparation Example 2

The procedure of Preparation Example 1 is repeated, except that 4-t-butylphenol is used in an amount of 0.2 equivalents.

### Preparation Example 3

The procedure of Preparation Example 1 was repeated, except that 4-t-butylphenol was used in an amount of 0.5 equivalents

### Preparation Example 4

The procedure of Preparation Example 1 is repeated, except that bisphenol A is used instead of the biphenol.

Methods for Evaluation of Physical Properties

(1) Weight average molecular weight (g/mol): 0.01 g of a sample of each of the biphenyl polyphosphonates is dissolved in 2 mL of methylene chloride (MC), diluted with about 10 mL of THF, filtered through a 0.45 μm syringe filter, followed by gel permeation chromatography (GPC).

(2) Acid value (KOH mg/g): 1-20 g of a sample of each of the biphenyl polyphosphonates is dissolved in dimethyl sulfoxide (50 ml) and 0.03-0.2 ml of a BTB solution is added thereto. Then, the resulting mixture is titrated with a 0.1 N NaOH solution. The acid value is calculated by the following Equation 1:

Acid value=[(Amount of 0.1 N NaOH solution consumed (ml))*(0.1 N NaOH solution factor)*5.61]/Sample amount (g) [Equation 1]

TABLE 1

| | Preparation | Preparation | Preparation | Preparation |
|---|---|---|---|---|
| | Example 1 | Example 2 | Example 3 | Example 4 |
| Diol component | Biphenol | Biphenol | Biphenol | Bisphenol A |
| Content of end- | 10 | 20 | 50 | 20 |
| capping agent | | | | |
| (mol %) | | | | |
| Weight average mole- | 19,400 | 4,800 | 2,600 | 3,400 |
| cular weight (Mw) | | | | |
| PDI | 3.4 | 2.2 | 1.9 | 1.9 |
| Acid value | 0.01 | 0.01 | 0.01 | 0.01 |
| (KOH mg/g) | | | | |

### Examples 1-6 and Comparative Examples 1-4

### Preparation of Thermoplastic Resin Compositions

As shown in Table 2, each of the flame retardants is fed to 100 parts by weight of a polycarbonate resin (PANLITE L-1250W). The mixture is extruded in a general twin-screw extruder at 200-280° C. to produce a specimen. The physical properties of the specimen are evaluated by the following methods. The results are shown in Table 2.

(1) Heat resistance (VST, ° C.) is measured at 5 kg and 50° C./HR in accordance with ISO R 306.

(2) Izod impact strength (kgf·cm/cm) of a ⅛″ thick notched Izod specimen is evaluated at room temperature in accordance with ASTM D-256.

(3) Flame retardancy of a ⅛″ thick specimen is measured in accordance with UL-94.

(4) Total light transmittance (%)=(Light transmitted through the specimen)/(Light incident on the specimen)×100

Total light transmittance is measured using a color computer manufactured by Suga Instrument Corporation, Japan. The specimen has a thickness of 3.0 mm.

(5) Haze (%)=(Diffuse transmittance)/(Total light transmittance)×100

Haze is measured using a color computer manufactured by Suga Instrument Corporation, Japan. The specimen has a thickness of 3.0 mm.

TABLE 2

| | | Example | | | | | | Comparative Example | | | |
|---|---|---|---|---|---|---|---|---|---|---|---|
| | | 1 | 2 | 3 | 4 | 5 | 6 | 1 | 2 | 3 | 4 |
| Polycarbonate | | 100 | 100 | 100 | 100 | 100 | 100 | 100 | 100 | 100 | 100 |
| Flame | Monomeric | — | — | — | — | — | — | 5 | 10 | — | — |
| retardant | Preparation Example 1 | 5 | 10 | — | — | — | — | — | — | — | — |
| | Preparation Example 2 | — | — | 5 | 10 | — | — | — | — | — | — |
| | Preparation Example 3 | — | — | — | — | 5 | 10 | — | — | — | — |
| | Preparation Example 4 | — | — | — | — | — | — | — | — | 5 | 10 |

| | | | | | | | | | | |
|---|---|---|---|---|---|---|---|---|---|---|
| Heat resistance (VST) | 145 | 142 | 143 | 139 | 140 | 137 | 130 | 118 | 135 | 132 |
| Impact strength | 53.2 | 10.2 | 54.5 | 9.0 | 13.0 | 8.5 | 9.0 | 6.6 | 12.3 | 8.0 |
| Flame retardancy | V-2 | V-2 | V-2 | V-2 | V-2 | V-2 | V-2 | V-2 | V-2 | V-2 |
| Total light transmittance (%) | 87.0 | 86.5 | 88.5 | 87.0 | 89.2 | 89.1 | 86.8 | 88.0 | 88.6 | 88.6 |
| Haze | 6.5 | 3.0 | 4.3 | 2.1 | 1.7 | 1.8 | 4.9 | 2.2 | 5.1 | 1.8 |

As can be seen from the results in Table 2, the thermoplastic resin compositions of Comparative Examples 1-2 using a monomeric flame retardant exhibit poor resistance to impact and heat when compared to those of Comparative Examples 3-4 using the polyphosphonate. The thermoplastic resin compositions of Examples 1-6 using the respective biphenyl polyphosphonates are confirmed to have better impact strength, heat resistance, appearance and transparency than those of Comparative Examples 3-4 using the polyphosphonate having bisphenol moieties.

### Examples 7-8 and Comparative Examples 5-8

### Preparation of Thermoplastic Resin Compositions

As shown in Table 3, each of the flame retardants is fed to 100 parts by weight of base resins including 55 parts by weight of (A) an aromatic vinyl resin and 45 parts by weight of (B) polyphenylene ether (PPE). The mixture is extruded in a general twin-screw extruder at 200-280° C. to produce pellets. The pellets are dried at 70° C. for 2 hr and molded using a 10 oz injection molding machine at 200-280° C. to produce a specimen. The mold temperature is 40-80° C. The physical properties of the specimen are evaluated by the following methods. The results are shown in Table 3.

Detailed specifications of the components used in Examples 7-8 and Comparative Examples 5-8 are as follows:

(A) Aromatic vinyl resin: HIPS resin (HG-1730, Cheil Industries Inc., Korea)

(B) Polyphenylene ether (PPE) resin: Poly(2,6-dimethylphenyl ether) (S-202, Asahi Kasei Corporation, Japan)

(C) Flame retardants

(C-1) Biphenyl polyphosphonate prepared in Preparation Example 3.

(C-2) Polyphosphate containing bisphenol moieties

1 equivalent of bisphenol A (Songwon Industrial Co., Ltd., Korea), 0.2 equivalents (20 mol %) of 4-t-butylphenol as an end-capping agent, and 0.01 equivalents of aluminum chloride are added to chlorobenzene whose amount is 6 times larger than that of the biphenol. The mixture is heated to 131° C., and then 1 equivalent of phenylphosphonic dichloride (Acros) is added dropwise thereto to initiate the reaction. After the dropwise addition is finished, the resulting mixture is further stirred for 2 hr. After completion of the reaction, the reaction mixture is cooled to 80° C., washed with a 10% aqueous hydrochloric acid solution, and washed twice with water. Thereafter, the aqueous layer is discarded and the organic layer is distilled under reduced pressure, affording a polyphosphonate containing bisphenol moieties C-2. The polymer is found to have a weight average molecular weight of 3,400 g/mol, a PDI of 1.9 and an acid value of 0.01 mg KOH/g.

(C-3) Phosphate-based flame retardant: CR-741 (Dihachi).

Methods for Evaluation of Physical Properties

(1) Heat resistance (VST, ° C.) is measured at 5 kg and 50° C./HR in accordance with ISO R 306.

(2) Flame retardancy of a ⅛″ (3t) thick specimen is measured in accordance with UL-94.

(3) Izod impact strength (kgf·cm/cm) of a ⅛″ thick notched Izod specimen is evaluated at room temperature in accordance with ASTM D-256.

TABLE 3

| | | Example No. | | Comparative Example No. | | | |
|---|---|---|---|---|---|---|---|
| | | 7 | 8 | 5 | 6 | 7 | 8 |
| (A) HIPS | | 55 | 55 | 55 | 55 | 55 | 55 |
| (B) PPE | | 45 | 45 | 45 | 45 | 45 | 45 |
| (C) Flame | (C-1) | 15 | 20 | — | — | — | — |
| retardant | (C-2) | — | — | — | — | 15 | 20 |
| | (C-3) | — | — | 15 | 20 | — | — |

| | | | | | | |
|---|---|---|---|---|---|---|
| Vicat softening | 129 | 126 | 103 | 103 | 124 | 125 |
| temperature (VST) | | | | | | |
| Flame retardancy | V-1 | V-1 | V-1 | V-1 | V-1 | V-1 |
| Impact strength | 9.1 | 8.8 | 7.9 | 7.2 | 8.5 | 8.2 |

As can be seen from Table 3, the thermoplastic resin compositions of Comparative Examples 5-6 using the monomeric flame retardant exhibit poor resistance to impact and heat, as compared to Comparative Examples 7-8 using the polyphosphonate. It is confirmed that the thermoplastic resin compositions of Examples 7-8 using the biphenyl polyphosphonate have better impact strength, heat resistance than Comparative Examples 7-8 using the polyphosphonate having bisphenol moieties.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A biphenyl polyphosphonate represented by Formula 1: 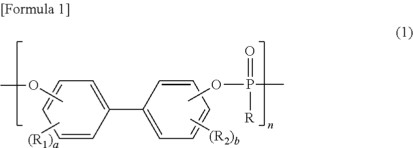
wherein:
R is hydrogen, substituted or unsubstituted C₁-C₅ alkyl, substituted or unsubstituted C₂-C₅ alkenyl, substituted or unsubstituted C₅-C₆ cycloalkyl, substituted or unsubstituted C₅-C₆ cycloalkenyl, substituted or unsubstituted C₆-C₂₀ aryl, or substituted or unsubstituted C₆-C₂₀ aryloxy,
R₁ and R₂ are the same or different and are each independently substituted or unsubstituted C₁-C₆ alkyl, substituted or unsubstituted C₅-C₆ cycloalkyl, substituted or unsubstituted C₆-C₁₂ aryl, or halogen,
a and b are the same or different and are each independently an integer from about 0 to about 4, and
n is an integer from about 4 to about 500.

2. The biphenyl polyphosphonate of claim 1, wherein the biphenyl polyphosphonate has a weight average molecular weight of about 1,000 to about 50,000 g/mol.

3. The biphenyl polyphosphonate of claim 1, wherein the biphenyl polyphosphonate has an acid value of about 0.005 to about 4 KOH mg/g.

4. The biphenyl polyphosphonate of claim 1, wherein the biphenyl polyphosphonate has a polydispersity index (PDI) of about 1.0 to about 3.5.

5. The biphenyl polyphosphonate of claim 1, wherein the biphenyl polyphosphonate has a weight average molecular weight of about 1,000 to about 10,000 g/mol and a polydispersity index (PDI) of about 1.5 to about 3.0.

6. A method for preparing a biphenyl polyphosphonate represented by Formula 1, the method comprising reacting a biphenol represented by Formula 2, a phosphonic dichloride represented by Formula 3 and an end-capping agent in the presence of a Lewis acid catalyst: 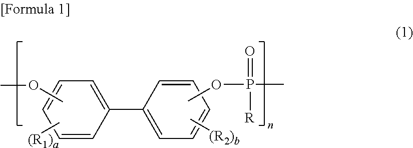
wherein in Formula 1:
R is hydrogen, substituted or unsubstituted C₁-C₅ alkyl, substituted or unsubstituted C₂-C₅ alkenyl, substituted or unsubstituted C₅-C₆ cycloalkyl, substituted or unsubstituted C₅-C₆ cycloalkenyl group, substituted or unsubstituted C₆-C₂₀ aryl, or a substituted or unsubstituted C₆-C₂₀ aryloxy,
R₁ and R₂ are the same or different and are each independently substituted or unsubstituted C₁-C₆ alkyl, substituted or unsubstituted C₅-C₆ cycloalkyl, substituted or unsubstituted C₆-C₁₂ aryl, or halogen,
a and b are the same or different and are each independently an integer from about 0 to about 4, and
n is an integer from about 4 to about 500,
and wherein in Formula 2: 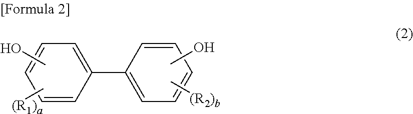
R₁, R₂, a and b are as defined in Formula 1,
and wherein in Formula 3: 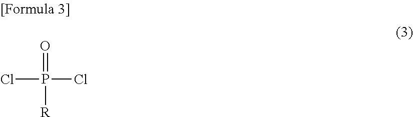
R is as defined in Formula 1.

7. The method of claim 1, wherein the end-capping agent is a C₁-C₅ alkyl group-containing phenol.

8. A thermoplastic resin composition comprising the biphenyl polyphosphonate of claim 1 and a thermoplastic resin.

9. The thermoplastic resin composition of claim 8, wherein the thermoplastic resin composition comprises about 100 parts by weight of the thermoplastic resin and about 0.1 to about 30 parts by weight of the biphenyl polyphosphonate.

10. The thermoplastic resin composition of claim 8, wherein the thermoplastic resin composition has a heat resistance of about 136 to about 160° C., as measured at 5 kg and 50° C./HR in accordance with ISO R 306, a ⅛″ notched Izod impact strength of about 8.5 to about 80 kgf·cm/cm, as measured in accordance with ASTM D-256, and a flame retardancy rating of V-2 or better, as measured at a thickness of ⅛″ in accordance with UL94 V.

11. The thermoplastic resin composition of claim 8, wherein the thermoplastic resin is a polycarbonate resin.

12. The thermoplastic resin composition of claim 8, wherein the thermoplastic resin comprises an aromatic vinyl resin and a polyphenylene oxide resin.

13. The thermoplastic resin composition of claim 12, wherein the thermoplastic resin comprises about 50 to about 99% by weight of the aromatic vinyl resin and about 1 to about 50% by weight of the polyphenylene oxide resin.

14. The thermoplastic resin composition of claim 13, wherein the aromatic vinyl resin is a polymer of about 1 to about 30% by weight of a rubbery polymer and about 70 to about 99% by weight of an aromatic vinyl monomer.

15. The thermoplastic resin composition of claim 8, further comprising a flame retardant assistant, lubricant, plasticizer, heat stabilizer, anti-drip agent, antioxidant, compatibilizer, light stabilizer, pigment, dye, inorganic additive, or a combination thereof.

16. A molded article produced by molding the thermoplastic resin composition of claim 8.
